(19) United States
(12) Patent Application Publication
(10) Pub. No.: US 2010/0124434 A1
(43) Pub. Date: May 20, 2010

(54) LIGHT SOURCE DEVICE, OPTICAL SCANNING DEVICE, AND IMAGE FORMING APPARATUS

(76) Inventor: Hibiki Tatsuno, Kanagawa (JP)

Correspondence Address: DICKSTEIN SHAPIRO LLP, 1825 EYE STREET NW, Washington, DC, 20006-5403, US

(21) Appl. No.: 12/611,163

(22) Filed: Nov. 3, 2009

(30) Foreign Application Priority Data
Nov. 20, 2008 (JP) 2008-296196

(51) Int. Cl. G03G 15/22; G03G 15/04

(52) U.S. Cl. 399/151; 399/221

(57) ABSTRACT

A coupling optical system that couples a light beam from a light source. A separation optical element on which the light beam is incident through the coupling optical system includes an opening through which a part of the light beam having a highest light intensity passes, and reflects other part of the light beam incident on a surrounding area of the opening as a monitoring light beam. A light shielding member includes at least one of a light shielding portion arranged on an optical path between the light source and the coupling optical system and a light shielding portion arranged on an optical path between the coupling optical system and the separation optical system.

### CROSS-REFERENCE TO RELATED APPLICATIONS

The present application claims priority to and incorporates by reference the entire contents of Japanese Patent Application No. 2008-296196 filed in Japan on Nov. 20, 2008.

### BACKGROUND OF THE INVENTION

1. Field of the Invention

The present invention relates to a light source device, an optical scanning device, and an image forming apparatus, and more particularly, to a light source device that can monitor light intensity of beams emitted, an optical scanning device including the light source device, and an image forming apparatus including the optical scanning device.

2. Description of the Related Art

In electrophotographic image recording, an image forming apparatus using a laser as a light source has been widely used. In this case, the image forming apparatus includes an optical scanning device to scan a surface of a photosensitive drum with beams emitted from the light source and deflected by a deflector (scanning beams), thereby forming a latent image on the surface of the photosensitive drum.

In image forming apparatuses, a quantity of light of scanning beams changes with a change in temperature and a change with a passage of time, and density unevenness can occur in a finally output image (an output image). To suppress this problem, in an optical scanning device, auto power control (APC) is generally performed. In the APC, a part of beams emitted from a light source is received as monitoring beams by a detector such as a photodiode, and a drive signal of the light source is controlled based on a result thereof (for example, see Japanese Patent Application Laid-open No. H10-100476, Japanese Patent Application Laid-open No. 2002-26445, Japanese Patent Application Laid-open No. 2005-274678, Japanese Patent Application Laid-open No. H6-164070, and Japanese Patent Application Laid-open No. 2007-298563).

Recently, image forming apparatuses are also used for simple printing as an on-demand printing system, and downsizing and high-density image quality have been desired. However, as for the conventional apparatuses disclosed in the patent documents mentioned above, it has been difficult to realize high light use efficiency and while achieving downsizing.

### SUMMARY OF THE INVENTION

It is an object of the present invention to at least partially solve the problems in the conventional technology.

According to one aspect of the present invention, there is provided a light source device that provides a light beam. The light source device includes: a light source that emits a light beam; a coupling optical system that couples the light beam; a separation optical element on which the light beam is incident through the coupling optical system, the separation optical element including an opening through which a part of the light beam having a highest light intensity passes, and reflecting other part of the light beam incident on a surrounding area of the opening as a monitoring light beam; and a light shielding member including at least one of a light shielding portion that is arranged on an optical path between the light source and the coupling optical system to shield a part of the light beam traveling toward an outside of an effective area of the coupling optical system and a light shielding portion that is arranged on an optical path between the coupling optical system and the separation optical system to shield a part of the light beam passed through the outside of the effective area of the coupling optical system.

Furthermore, according to another aspect of the present invention, there is provided an optical scanning device that scans a scanning surface with a light beam. The optical scanning device includes: a light source device including a light source that emits a light beam, a coupling optical system that couples the light beam, a separation optical element on which the light beam is incident through the coupling optical system, the separation optical element including an opening through which a part of the light beam having a highest light intensity passes, and reflecting other part of the light beam incident on a surrounding area of the opening as a monitoring light beam, and a light shielding member including at least one of a light shielding portion that is arranged on an optical path between the light source and the coupling optical system to shield a part of the light beam traveling toward an outside of an effective area of the coupling optical system and a light shielding portion that is arranged on an optical path between the coupling optical system and the separation optical system to shield a part of the light beam passed through the outside of the effective area of the coupling optical system; a deflector that deflects the light beam from the light source device; and a scanning optical system that condenses the light beam deflected by the deflector onto a scanning surface to be scanned.

Moreover, according to still another aspect of the present invention, there is provided an image forming apparatus that forms an image on a recording medium. The image forming apparatus includes: at least one image carrier; and at least one optical scanning device that scans the at least one image carrier by a light beam that is modulated based on image information. The optical scanning device includes: a light source device that provides the light beam; a deflector that deflects the light beam from the light source device; and a scanning optical system that condenses the light beam deflected by the deflector onto a scanning surface to be scanned. The light source device includes a light source that emits a light beam, a coupling optical system that couples the light beam from the light source, a separation optical element on which the light beam coupled by the coupling optical system is incident, the separation optical element including an opening through which a part of the light beam having a highest light intensity passes, and reflecting other part of the light beam incident on a surrounding area of the opening as a monitoring light beam, and a light shielding member including at least one of a light shielding portion that is arranged on an optical path between the light source and the coupling optical system to shield a part of the light beam traveling toward an outside of an effective area of the coupling optical system and a light shielding portion that is arranged on an optical path between the coupling optical system and the separation optical system to shield a part of the light beam passed through the outside of the effective area of the coupling optical system.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a configuration of a laser printer according to an embodiment of the present invention;

FIG. 2 is a schematic diagram of an optical scanning device in FIG. 1;

FIG. 3 is a schematic diagram for explaining a light source device in FIG. 2;

FIG. 4 is a schematic diagram for explaining a surface-emitting laser array included in a light source in FIG. 3;

FIG. 5 is a schematic diagram for explaining an effective area of a coupling lens;

FIG. 6 is a schematic diagram for explaining an operation of a light shielding member;

FIG. 7 is a schematic diagram for explaining a normal direction of a light shielding surface in a light shielding portion of the light shielding member;

FIG. 8 is a schematic diagram for explaining a first aperture plate in FIG. 3;

FIG. 9 is a schematic diagram for explaining a second aperture plate in FIG. 3;

FIG. 10 is a schematic diagram for explaining a holding member;

FIG. 11 is a block diagram for explaining a configuration of a light source controller;

FIG. 12 is a schematic diagram for explaining a first modification of the holding member;

FIG. 13 is a schematic diagram for explaining an operation of a light shielding member;

FIG. 14 is a schematic diagram for explaining a second modification of the holding member;

FIG. 15 is a schematic diagram for explaining a fixing member; and

FIG. 16 depicts a schematic configuration of a color printer.

### DETAILED DESCRIPTION OF THE PREFERRED EMBODIMENTS

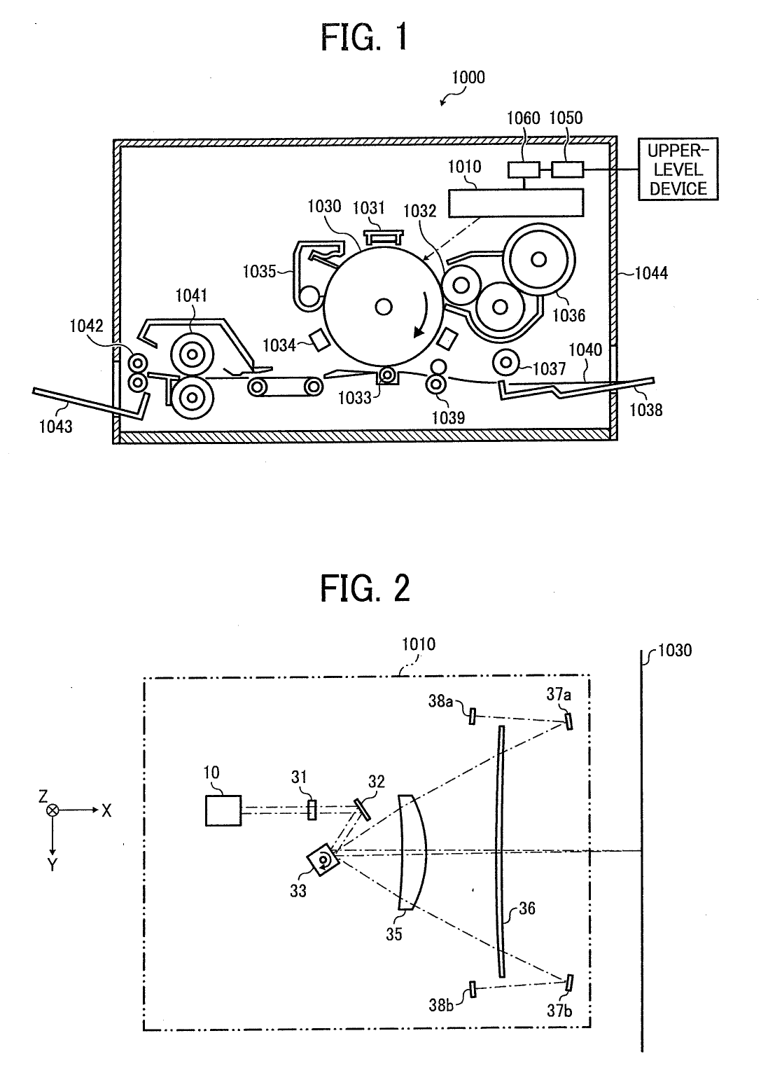

Exemplary embodiments of the present invention will be explained below in detail with reference to the accompanying drawings. FIG. 1 depicts a schematic configuration of a laser printer 1000 as an image forming apparatus according to an embodiment of the present invention.

The laser printer 1000 includes an optical scanning device 1010, a photosensitive drum 1030, an electrification charger 1031, a developing roller 1032, a transfer charger 1033, a neutralizing unit 1034, a cleaning unit 1035, a toner cartridge 1036, a paper feed roller 1037, a paper feed tray 1038, a registration roller pair 1039, a fuser roller pair 1041, an ejection roller pair 1042, an ejection tray 1043, a communication controller 1050, and a printer controller 1060 that generally controls these units. These units are accommodated at predetermined positions of a printer housing 1044.

The communication controller 1050 controls two-way communications between an upper-level device (such as a personal computer) and the laser printer 1000 via a network.

The photosensitive drum 1030 is a columnar member, and a photosensitive layer is formed on a surface thereof. That is, the surface of the photosensitive drum 1030 is a scanning target surface. The photosensitive drum 1030 rotates in an arrow direction in FIG. 1.

The electrification charger 1031, the developing roller 1032, the transfer charger 1033, the neutralizing unit 1034, and the cleaning unit 1035 are arranged near the surface of the photosensitive drum 1030. These are arranged along a rotation direction of the photosensitive drum 1030 in an order of the electrification charger 1031, the developing roller 1032, the transfer charger 1033, the neutralizing unit 1034, and the cleaning unit 1035.

The electrification charger 1031 uniformly charges the surface of the photosensitive drum 1030.

The optical scanning device 1010 irradiates beams modulated based on image information from the upper-level device onto the surface of the photosensitive drum 1030 charged by the electrification charger 1031. Accordingly, a latent image corresponding to the image information is formed on the surface of the photosensitive drum 1030. The formed latent image moves toward the developing roller 1032 with a rotation of the photosensitive drum 1030. A configuration of the optical scanning device 1010 will be described later.

Toner is stored in the toner cartridge 1036 and the toner is supplied to the developing roller 1032.

The developing roller 1032 causes the toner supplied from the toner cartridge 1036 to adhere on the latent image formed on the surface of the photosensitive drum 1030, to visualize the image information. The latent image on which the toner adheres (hereinafter, “toner image” for convenience) moves toward the transfer charger 1033 with the rotation of the photosensitive drum 1030.

Recording paper 1040 is stored in the paper feed tray 1038. The paper feed roller 1037 is arranged near the paper feed tray 1038, and the paper feed roller 1037 takes out the recording paper 1040 one by one from the paper feed tray 1038, and carries it to the registration roller pair 1039. The registration roller pair 1039 temporarily holds the recording paper 1040 taken out by the paper feed roller 1037, and sends it out toward a gap between the photosensitive drum 1030 and the transfer charger 1033, matched with the rotation of the photosensitive drum 1030.

A voltage with an opposite polarity to the polarity of the toner is applied to the transfer charger 1033, to electrically attract the toner on the surface of the photosensitive drum 1030 to the recording paper 1040. A toner image on the surface of the photosensitive drum 1030 is transferred to the recording paper 1040. The recording paper 1040 to which the toner image is transferred is carried to the fuser roller pair 1041.

Heat and pressure are applied to the recording paper 1040 by the fuser roller pair 1041, and thus the toner is fixed on the recording paper 1040. The recording paper 1040 on which the toner is fixed is carried to the ejection tray 1043 via the ejection roller pair 1042, and sequentially stacked on the ejection tray 1043.

The neutralizing unit 1034 neutralizes the surface of the photosensitive drum 1030.

The cleaning unit 1035 removes toner remaining on the surface of the photosensitive drum 1030 (residual toner). The surface of the photosensitive drum 1030 with the residual toner being removed returns to a position facing the electrification charger 1031.

The configuration of the optical scanning device 1010 is explained next.

The optical scanning device 1010 includes, as shown in FIG. 2 as an example, a light source device 10, a cylindrical lens 31, a scanning-beam reflecting mirror 32, a polygon mirror 33, a deflector-side scanning lens 35, an image-surface-side scanning lens 36, two photo-detection mirrors (37a, 37b), and two photo-detection sensors (38a, 38b). These units are incorporated at predetermined positions in a housing.

In the present specification, in an XYZ three-dimensional rectangular coordinate system, a direction along a longitudinal direction of the photosensitive drum 1030 is explained as a Y-axis direction, and a direction along an optical axis of the respective scanning lenses (the deflector-side scanning lens 35 and the image-surface-side scanning lens 36) is explained as an X-axis direction. Further, in the following explanations, a direction corresponding to a main scanning direction is abbreviated as “main-scanning corresponding direction”, and a direction corresponding to a sub-scanning direction is abbreviated as “sub-scanning corresponding direction” for convenience.

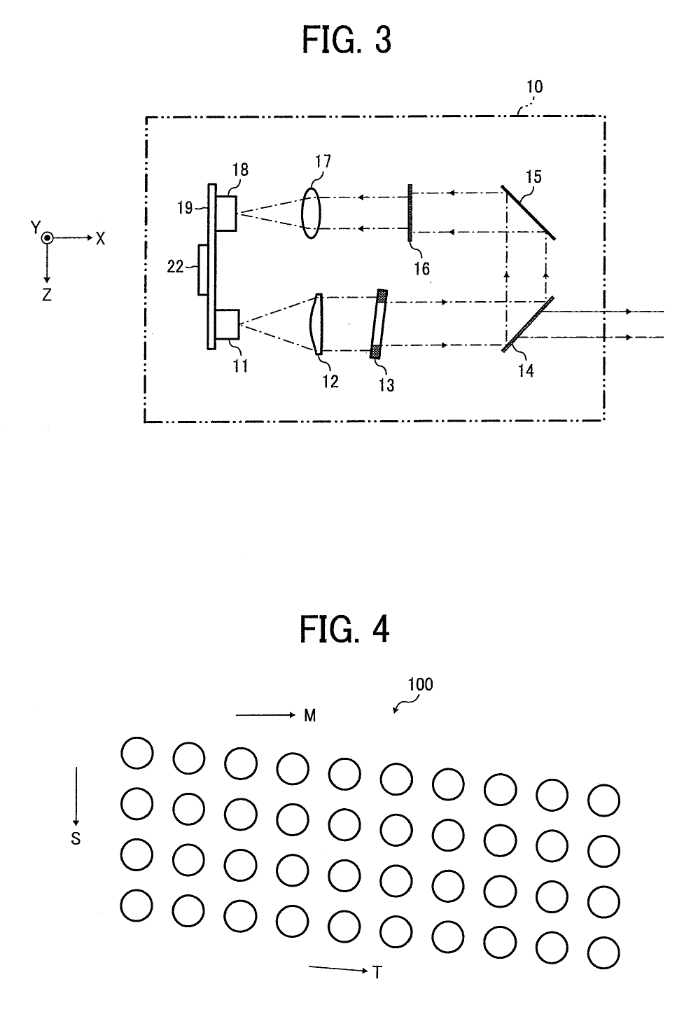

The light source device 10 includes, as shown in FIG. 3 as an example, a light source 11, a coupling lens 12, a light shielding member 13, a first aperture plate 14, a monitoring-beam reflecting mirror 15, a second aperture plate 16, a condenser lens 17, a light receiving element 18, and a light source controller 22. The light source 11, the light receiving element 18, and the light source controller 22 are respectively mounted on a same circuit board 19.

As shown in FIG. 4 as an example, the light source 11 has a two-dimensional array 100 in which forty light emitting units are arranged two-dimensionally and formed on one board. An M direction in FIG. 4 is the main-scanning corresponding direction (same as the Y-axis direction), and an S direction is the sub-scanning corresponding direction (same as the Z-axis direction). A T direction is a direction inclined from the M direction toward the S direction.

The two-dimensional array 100 has four light-emitting arrays in which ten light emitting units are arranged with equal intervals along the T direction. These four arrays of light emitting units are arranged in the S direction with equal intervals so that these arrays have equal intervals therebetween when these are orthogonally projected on a virtual line extending in the S direction. In the present specification, “interval between the light emitting units” refers to a distance between centers of two light emitting units.

Each of the light emitting unit is a vertical-cavity surface-emitting laser (VCSEL) having an emission wavelength of 780 nanometers. That is, the two-dimensional array 100 is a surface-emitting laser array having forty light emitting units.

It is assumed that beams are emitted from the light source 11 toward a +X direction.

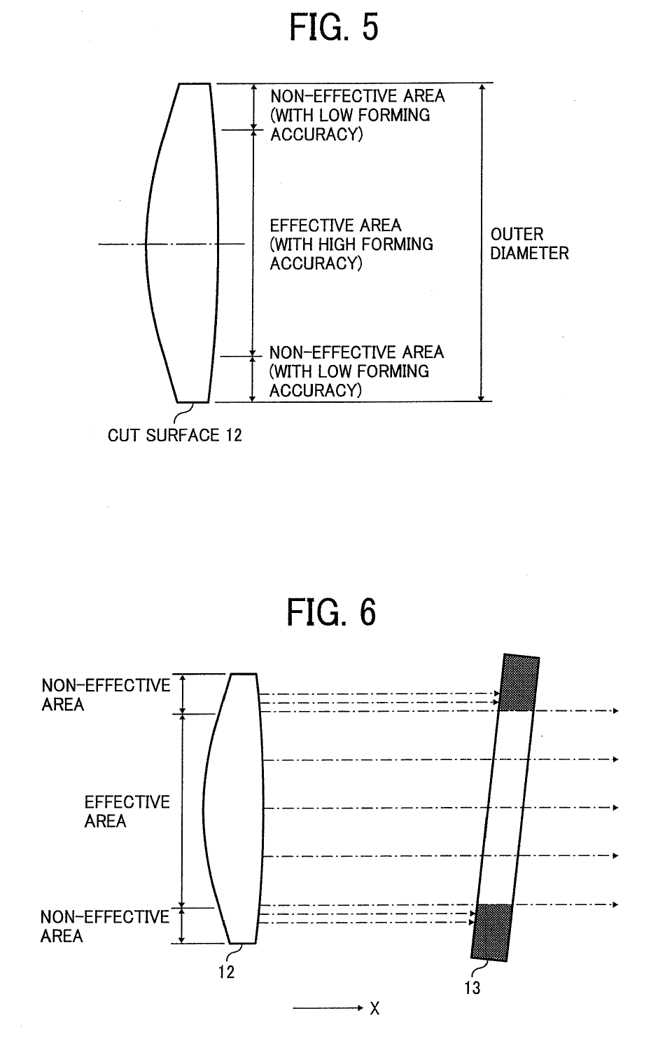

The coupling lens 12 is arranged on a +X side of the light source 11, to make the beams emitted from the light source 11 substantially parallel beams. As shown in FIG. 5 as an example, the coupling lens 12 has an effective area with high forming accuracy and a non-effective area with low forming accuracy around the effective area.

The light shielding member 13 is arranged on a +X side of the coupling lens 12, and as shown in FIG. 6 as an example, transmits beams having passed through the effective area of the coupling lens 12 and shields the beams having passed through the non-effective area.

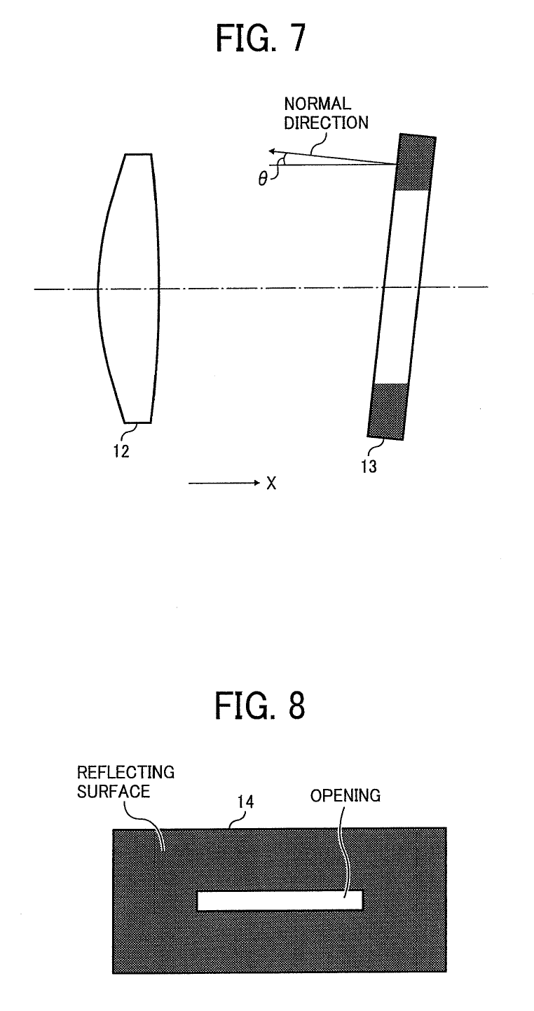

A normal direction of a light shielding surface in a light shielding portion of the light shielding member 13 is inclined, as shown in FIG. 7 as an example, with respect to a direction parallel to an optical axis of the coupling lens 12 (the X-axis direction). An inclination angle θ of the light shielding surface in the normal direction satisfies a relation of L×tan(90-θ)>1, using a distance L in the X-axis direction between the light shielding surface and the light source 11.

As shown in FIG. 8 as an example, the first aperture plate 14 is arranged on a +X side of the light shielding member 13 and has an opening to define a beam diameter of the beams having passed through the light shielding member 13. A surrounding surface of the opening of the first aperture plate 14 is coated with aluminum or silver to have high reflectivity. The first aperture plate 14 is arranged so that a portion of incident beams having the largest light intensity passes substantially a center of the opening.

The first aperture plate 14 is also arranged to be inclined with respect to a virtual surface orthogonal to a direction parallel to the optical axis of the coupling lens 12 for using beams reflected by a surrounding area of the opening as monitoring beams. The first aperture plate 14 is arranged such that a traveling direction of the beams reflected by the surrounding area of the opening becomes a −Z direction (see FIG. 3).

The beams having passed through the opening in the first aperture plate 14 are beams emitted from the light source device 10.

The monitoring-beam reflecting mirror 15 is arranged on a −Z side of the first aperture plate 14, to fold back an optical path of the beams (monitoring beams) reflected by the first aperture plate 14 in a −X direction.

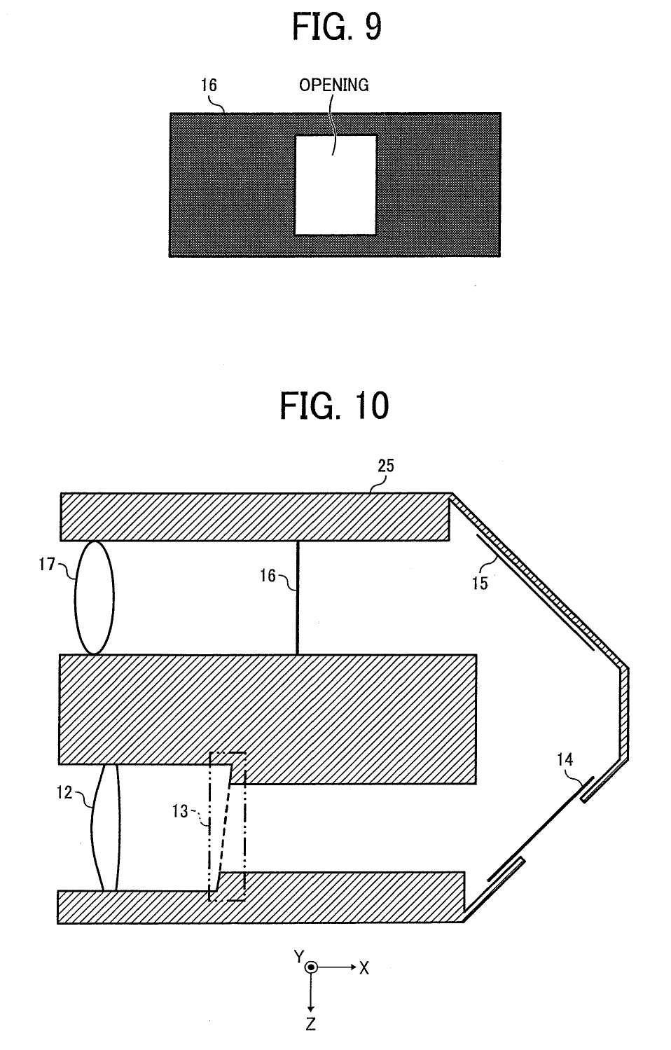

As shown in FIG. 9 as an example, the second aperture plate 16 is arranged on a −X side of the monitoring-beam reflecting mirror 15 and has an opening to define a beam diameter of the monitoring beams reflected by the monitoring-beam reflecting mirror 15. The size and shape of the opening in the second aperture plate 16 are determined according to the size and shape of the opening in the first aperture plate 14.

The condenser lens 17 is arranged on the −X side of the second aperture plate 16, to condense the monitoring beams having passed through the opening in the second aperture plate 16.

The light receiving element 18 is arranged on the circuit board 19 and on the −X side of the condenser lens 17, to receive the monitoring beams. The light receiving element 18 outputs a signal corresponding to a quantity of received light (a photoelectric conversion signal).

An optical system arranged on the optical path of the monitoring beams between the first aperture plate 14 and the light receiving element 18 is also referred to as a monitoring optical system. In the present embodiment, the monitoring optical system includes the monitoring-beam reflecting mirror 15, the second aperture plate 16, and the condenser lens 17.

As shown in FIG. 10, as an example, the coupling lens 12, the first aperture plate 14, the monitoring-beam reflecting mirror 15, the second aperture plate 16, and the condenser lens 17 are held by a holding member 25 in a predetermined positional relation. The light shielding member 13 is integrally formed with the holding member 25.

While the holding member 25 is an integrated member by using a mold, it can be produced by cutting.

Referring back to FIG. 2, the cylindrical lens 31 is arranged on the +X side of the light source device 10, and images beams having passed through the opening in the first aperture plate 14 of the light source device 10, that is, beams emitted from the light source device 10 near a deflection reflecting surface of the polygon mirror 33 via the scanning-beam reflecting mirror 32 in the Z-axis direction.

The optical system arranged on the optical axis between the light source 11 and the polygon mirror 33 is also referred to as a pre-deflector optical system. In the present embodiment, the pre-deflector optical system includes the coupling lens 12, the first aperture plate 14, the cylindrical lens 31, and the scanning-beam reflecting mirror 32.

The polygon mirror 33 has a tetrahedral mirror with a radius of an inscribed circle being 7 millimeters as an example, and each mirror becomes a deflection reflecting surface. The polygon mirror 33 deflects beams from the scanning-beam reflecting mirror 32, while rotating around a shaft parallel with the Z-axis direction at constant velocity.

The deflector-side scanning lens 35 is arranged on the optical path of the beams deflected by the polygon mirror 33.

The image-surface-side scanning lens 36 is arranged on the optical path of the beams via the deflector-side scanning lens 35. The beams via the image-surface-side scanning lens 36 are irradiated onto the surface of the photosensitive drum 1030 to form an optical spot. The optical spot moves in a longitudinal direction of the photosensitive drum 1030 with the rotation of the polygon mirror 33. That is, the optical spot scans on the photosensitive drum 1030. The moving direction of the optical spot is “the main scanning direction”, and the rotation direction of the photosensitive drum 1030 is “the sub-scanning direction”.

The optical system arranged on the optical path between the polygon mirror 33 and the photosensitive drum 1030 is also referred to as a scanning optical system. In the present embodiment, the scanning optical system includes the deflector-side scanning lens 35 and the image-surface-side scanning lens 36. At least one folding mirror can be arranged on at least one of the optical paths of the optical path between the deflector-side scanning lens 35 and the image-surface-side scanning lens 36 and the optical path between the image-surface-side scanning lens 36 and the photosensitive drum 1030.

A part of beams before start of writing, deflected by the polygon mirror 33 and via the scanning optical system, enters into the photo-detection sensor 38a via the photo-detection mirror 37a. Further, a part of beams after end of writing, deflected by the polygon mirror 33 and via the scanning optical system, enters into the photo-detection sensor 38b via the photo-detection mirror 37b.

Each of the photo-detection sensors outputs a signal corresponding to the quantity of received light (a photoelectric conversion signal).

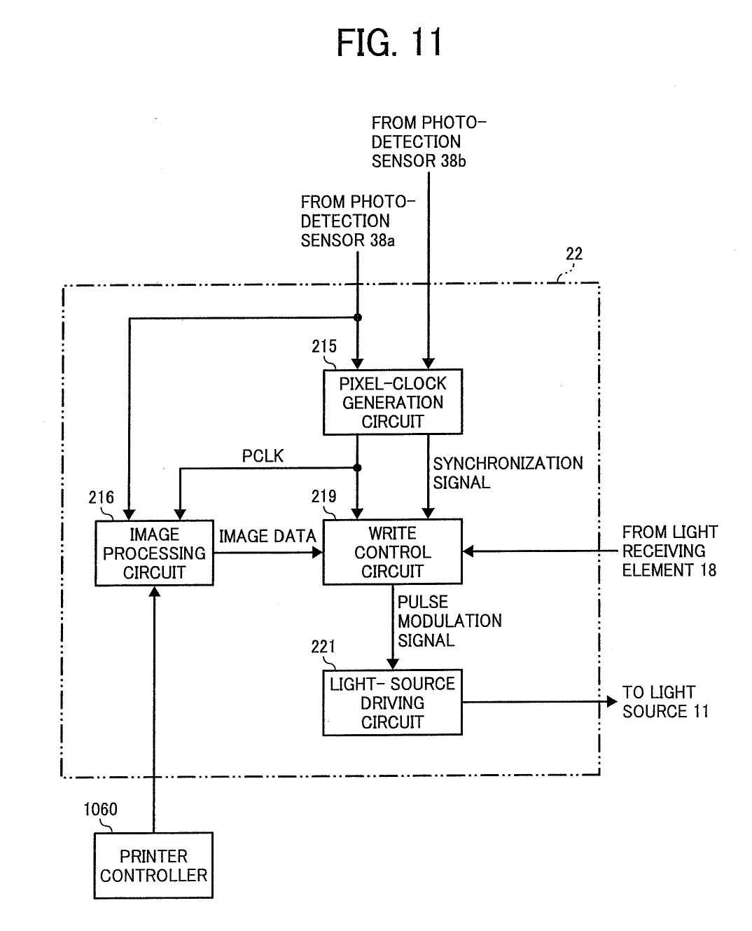

The light source controller 22 includes, as shown in FIG. 11 as an example, a pixel-clock generation circuit 215, an image processing circuit 216, a write control circuit 219, and a light-source driving circuit 221. Arrows in FIG. 11 indicate a flow of representative signals and information, and does not indicate overall connection of respective blocks.

The pixel-clock generation circuit 215 obtains a time required for the beams to scan between the respective photo-detection sensors based on an output signal of the photo-detection sensor 38a and an output signal of the photo-detection sensor 38b. The pixel-clock generation circuit 215 then sets a frequency so that a preset number of pulses are accommodated within the obtained time, to generate a pixel clock signal PCLK at the frequency. The pixel clock signal PCLK generated here is supplied to the image processing circuit 216 and the write control circuit 219. Further, the output signal of the photo-detection sensor 38a is output to the write control circuit 219 as a synchronization signal.

The image processing circuit 216 performs raster expansion on image information sent from the upper-level device via the printer controller 1060, and after performing a predetermined halftone process, generates image data expressing gradation of each pixel for each light emitting unit based on the pixel clock signal PCLK. Upon detection of start of scan based on the output signal of the photo-detection sensor 38a, the image processing circuit 216 outputs the image data to the write control circuit 219, in synchronization with the pixel clock signal PCLK.

The write control circuit 219 generates a pulse modulation signal based on the image data from the image processing circuit 216, the pixel clock signal PCLK from the pixel-clock generation circuit 215, and the synchronization signal. Further, the write control circuit 219 corrects a drive current of each light emitting unit so that the quantity of light of the beams passing through the opening in the first aperture plate 14 of the light source device 10 becomes constant. That is, the write control circuit 219 performs APC.

The light-source driving circuit 221 drives light emitting units in the two-dimensional array 100 based on the pulse modulation signal from the write control circuit 219.

As can be understood from the above explanations, in the light source device 10 according to the present embodiment, the coupling lens 12 forms a coupling optical system, and the first aperture plate 14 forms a separation optical element.

As described above, the light source device 10 includes the light source 11 having the surface-emitting laser array in which a plurality of light emitting units are arranged two-dimensionally, the coupling lens 12 that couples the beams from the light source 11, the light shielding member 13 having the light shielding surface that shields the beams having passed through the non-effective area of the coupling lens 12, and the first aperture plate 14 that has the opening and reflects the beams entering into the surrounding area of the opening as the monitoring beams, with a part of the beams having the largest light intensity, which have passed through the light shielding member 13, passing substantially the center of the opening. The light source device 10 further includes the light receiving element 18 that receives the monitoring beams and the monitoring optical system that leads the monitoring beams reflected by the first aperture plate 14 to the light receiving element 18.

In this case, it is possible to prevent that beams, which have passed through the coupling lens 12 and are not used for any of optical scanning and monitoring of the quantity of light, from entering into the first aperture plate 14 and the monitoring optical system. Therefore, a beam diameter of the beams entering into the first aperture plate 14 and the monitoring optical system decreases than in a conventional case, thereby enabling to downsize the first aperture plate 14 and the monitoring optical system than in the conventional case. Further, because the light shielded by the light shielding member 13 has not been used at all conventionally, light use efficiency is not degraded.

Accordingly, downsizing is possible without degrading the light use efficiency.

Further, because the normal direction of the light shielding surface of the light shielding member 13 is inclined with respect to the direction parallel with the optical axis of the coupling lens 12, it is suppressed that the beams reflected by the light shielding surface returns to the light source 11. Therefore, it can be prevented that the optical output of the light source 11 becomes unstable due to return light.

Because the first aperture plate 14 and the monitoring optical system are held by the holding member 25, it can be suppressed that a positional relation between the first aperture plate 14 and the second aperture plate 16 is deviated from a designed positional relation due to vibrations, for example. Therefore, high monitoring accuracy can be maintained. Further, an assembly operation at the time of production can be facilitated, and an inspection process and a tuning process before shipment can be simplified.

Because the light shielding member 13 is integrally formed with the holding member 25, an increase in the number of parts can be suppressed.

Further, the first aperture plate 14 is used as the separation optical element, to separate the beams having passed through the light shielding member 13 into the scanning beams and the monitoring beams. Accordingly, the light use efficiency can be improved as compared with a case of using a half mirror as the separation optical element. When a half mirror is used as the separation optical element, the quantity of light of scanning beams decreases because the monitoring beams are separated from the scanning beams.

Because the monitoring optical system has the second aperture plate 16 that defines the beam diameter of the monitoring beams, a ratio between the quantity of light of the beams passing through the opening in the first aperture plate 14 and the quantity of light of the monitoring beams received by the light receiving element 18 can be made constant. Therefore, the light source device 10 can emit stable beams by controlling the drive of the light source 11 so that the output of the light receiving element 18 maintains a predetermined value. Accordingly, APC can be performed with a simple algorithm.

Because the optical scanning device 1010 according to the present embodiment has the light source device 10, the surface of the photosensitive drum 1030 can be optically scanned accurately and stably, without increasing the size of the apparatus.

Because the light source 11 has a plurality of light emitting units, multiple scanning can be made simultaneously, thereby enabling to realize high-speed operations and high-density image formation.

Further, because the laser printer 1000 has the optical scanning device 1010, a high quality image can be formed without increasing the size of the apparatus.

In the present embodiment, there has been explained a case that the normal direction of the light shielding surface of the light shielding portion of the light shielding member 13 is inclined with respect to the direction parallel to the optical axis of the coupling lens 12. However, for example, when the light shielding surface is pearskin finished (finished as a non-gloss surface) or a paint that decreases reflectivity is applied to the light shielding surface, so that the light reflected by the light shielding surface does not return to the light source 11, the normal direction of the light shielding surface does not have to be inclined with respect to the direction parallel to the optical axis of the coupling lens 12.

In the present embodiment, a case that the light shielding member 13 is integrally formed with the holding member 25 has been explained. However, the present invention is not limited thereto, and the light shielding member 13 can be provided separately.

In the present embodiment, a case that the first aperture plate 14 and the monitoring optical system are held by the holding member 25 has been explained; however, the present invention is not limited thereto. For example, a part of the monitoring optical system can be held not by the holding member 25 but by the housing of the optical scanning device 1010.

In the present embodiment, a case that the first aperture plate 14 is arranged so that the traveling direction of the beams reflected by the surrounding area of the opening becomes a −Z direction has been explained; however, the present invention is not limited thereto.

In the present embodiment, a case that the two-dimensional array 100 has forty light emitting units has been explained; however, the present invention is not limited thereto.

In the present embodiment, a case that the light source 11 has the two-dimensional array 100 has been explained; however, the present invention is not limited thereto. For example, the light source 11 can have a one-dimensional array in which a plurality of light emitting units are arranged in line, instead of the two-dimensional array 100. Further, the light source 11 can have one light emitting unit instead of the two-dimensional array 100.

In the present embodiment, when a size of the opening in the light shielding member 13 is set to match a size of the opening in the second aperture plate 16, the second aperture plate 16 can be omitted.

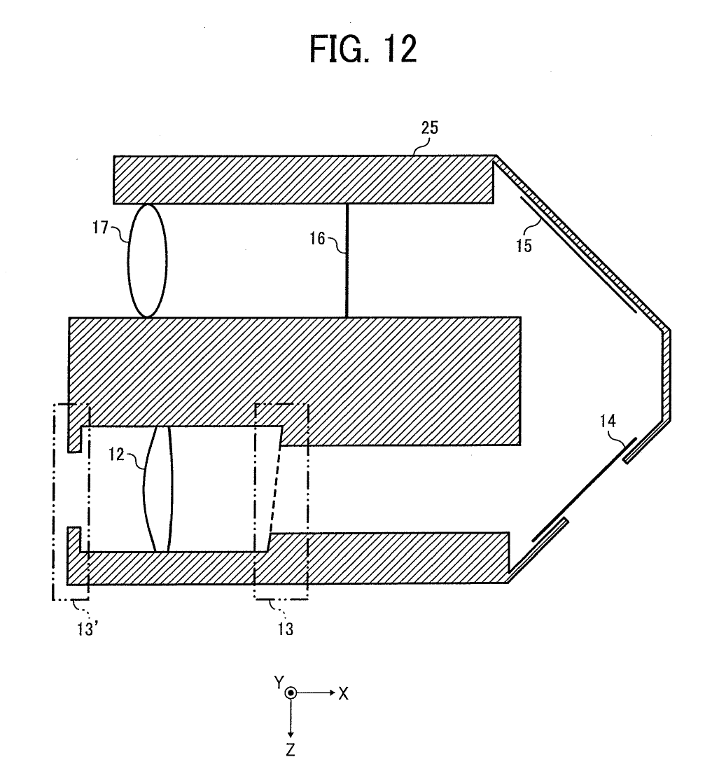

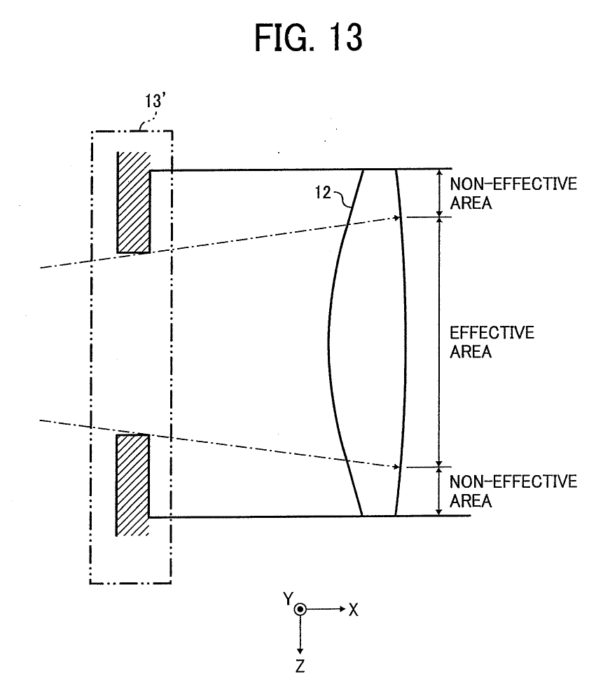

In the present embodiment, a light shielding member 13′ that shields the beams traveling toward the non-effective area of the coupling lens 12 to limit the beam diameter of the beams entering into the coupling lens 12 can be further arranged between the light source 11 and the coupling lens 12 (see FIGS. 12 and 13). The light shielding member 13′ can be integrated with the holding member 25 or provided separately.

In the present embodiment, the light shielding member 13′ that shields the beams traveling toward the non-effective area of the coupling lens 12 to limit the beam diameter of the beams entering into the coupling lens 12 can be arranged instead of the light shielding member 13 between the light source 11 and the coupling lens 12 (see

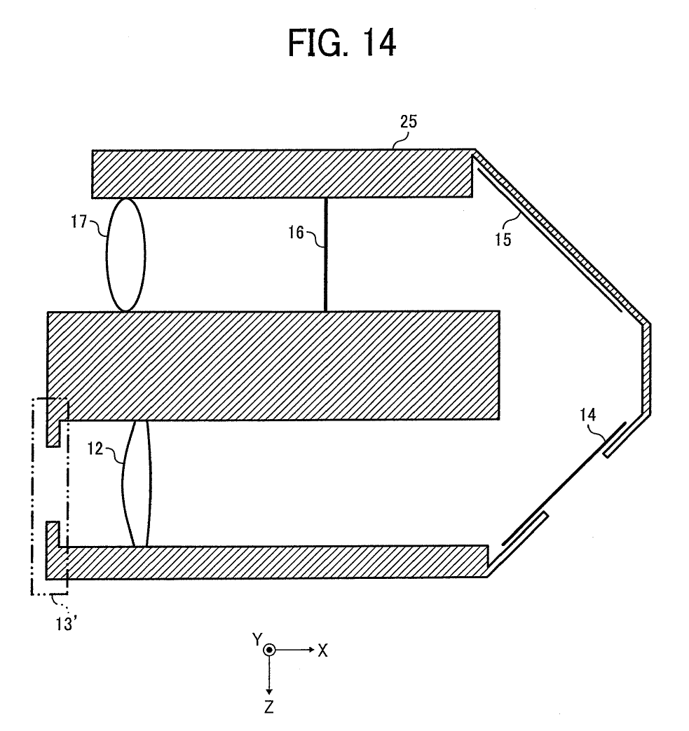

FIG. 14). The light shielding member 13′ can be integrated with the holding member 25 or provided separately.

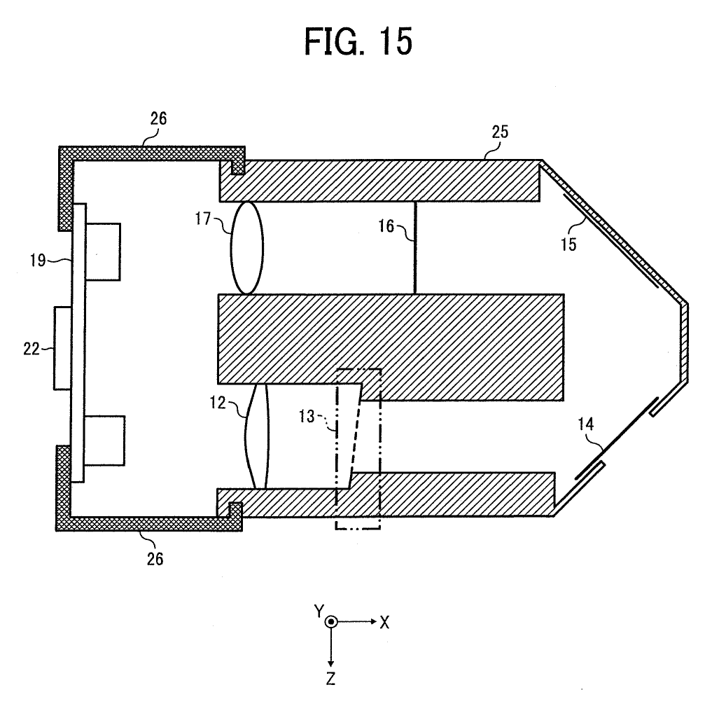

In the present embodiment, the holding member 25 and the circuit board 19 can be fixed by a fixing member 26 in a predetermined positional relation (see FIG. 15). Accordingly, an assembly operation at the time of production can be facilitated, and an inspection process and a tuning process before shipment can be simplified. Further, because it can be suppressed that a positional relation between the light receiving element 18 and the monitoring optical system is deviated from a designed positional relation, a large margin is not required for the size of the light receiving element 18. That is, the size of the light receiving element 18 can be decreased.

In the present embodiment, a case that the monitoring optical system is included in the light source device has been explained. However, the present invention is not limited thereto, and at least a part of the monitoring optical system can be provided separately.

In the present embodiment, a case that the image forming apparatus is the laser printer 1000 has been explained; however, the present invention is not limited thereto. In short, a high quality image can be formed in a stable manner as far as the image forming apparatus includes the optical scanning device 1010.

For example, the image forming apparatus can be an apparatus that irradiates laser beams directly to a medium (such as paper) that develops color by laser beams.

Further, the image forming apparatus can be an apparatus that uses a silver salt film as an image carrier. In this case, a latent image can be formed on the silver salt film by optical scanning, and the latent image can be visualized by a similar process to a development process in a general silver-salt photographic process. The latent image can be transferred onto printing paper by a similar process to a printing process in a general silver-salt photographic process. Such an image forming apparatus can be implemented as an optical plate-making apparatus or an optical drawing apparatus that draws CT scan images or the like.

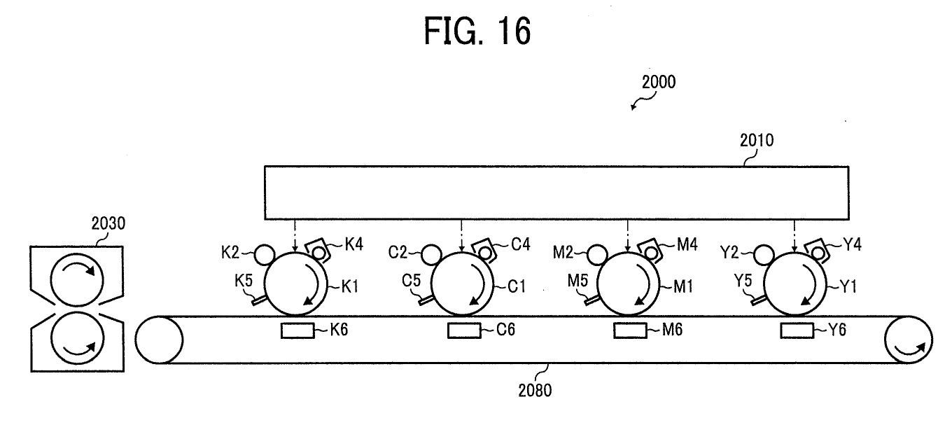

For example, as shown in FIG. 16, the image forming apparatus can be a color printer 2000 including a plurality of photosensitive drums.

The color printer 2000 is a tandem-type multicolor printer that forms full color images by superposing four colors (black, cyan, magenta, and yellow). The color printer 2000 includes a photosensitive drum K1, a charger K2, a developing apparatus K4, a cleaning unit K5, and a transfer apparatus K6 for black, a photosensitive drum C1, a charger C2, a developing apparatus C4, a cleaning unit C5, and a transfer apparatus C6 for cyan, a photosensitive drum M1, a charger M2, a developing apparatus M4, a cleaning unit M5, and a transfer apparatus M6 for magenta, and a photosensitive drum Y1, a charger Y2, a developing apparatus Y4, a cleaning unit Y5, and a transfer apparatus Y6 for yellow. The color printer 2000 further includes an optical scanning device 2010, a transfer belt 2080, and a fixing unit 2030.

The photosensitive drums rotate in a direction of arrows in FIG. 16, and chargers, developing apparatuses, transfer apparatuses, and cleaning units are respectively arranged in this order in a rotation direction around each photosensitive drum.

Each of the chargers uniformly charges the surface of a corresponding photosensitive drum. Optical scanning is performed by the optical scanning device 2010 with respect to the surface of each of the photosensitive drums charged by the charger, thereby forming a latent image on each of the photosensitive drums.

A toner image is then formed on the surface of each of the photosensitive drums by a corresponding developing apparatus. Further, a toner image of each color is sequentially transferred onto recording paper on the transfer belt 2080 by a corresponding transfer apparatus, and an image is finally fixed on the recording paper by the fixing unit 2030.

The optical scanning device 2010 includes a light source device similar to the light source device 10 for each color. Therefore, Effects identical to those of the optical scanning device 1010 can be achieved.

The color printer 2000 can achieve effects identical to those of the laser printer 1000.

In the tandem-type multicolor printer, color misregistration can occur between respective colors due to factors such as machine accuracy of the printer. However, correction accuracy of color misregistration between respective colors can be increased by selecting a light emitting unit to be lighted.

In the color printer 2000, the optical scanning device can be provided for each color, or provided in a unit of two colors.

According to one aspect of the present invention, downsizing of a device is possible without degrading the light use efficiency.

Furthermore, according to another aspect of the present invention, a scanning surface can be optically scanned in an accurate and stable manner without causing an increase in size of a device.

Moreover, according to still another aspect of the present invention, a high quality image can be formed without causing an increase in size of an apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A light source device comprising:
a light source that emits a light beam;
a coupling optical system that couples the light beam;
a separation optical element on which the light beam is incident through the coupling optical system, the separation optical element including an opening through which a part of the light beam having a highest light intensity passes, and reflecting other part of the light beam incident on a surrounding area of the opening as a monitoring light beam; and
a light shielding member including at least one of a light shielding portion that is arranged on an optical path between the light source and the coupling optical system to shield a part of the light beam traveling toward an outside of an effective area of the coupling optical system and a light shielding portion that is arranged on an optical path between the coupling optical system and the separation optical system to shield a part of the light beam passed through the outside of the effective area of the coupling optical system.

2. The light source device according to claim 1, further comprising a holding member that holds the coupling optical system and the separation optical system in a predetermined positional relationship, wherein
the holding member and the light shielding member are integrally formed.

3. The light source device according to claim 1, wherein a normal direction to a light shielding surface of the light shielding portion is inclined with respect to a direction parallel to an optical axis of the coupling optical system.

4. The light source device according to claim 3, wherein an inclination angle of the normal direction to the light shielding surface of the light shielding portion satisfies L×tan(90-θ)>1, where L is distance between the light source and the light shielding portion and θ is the inclination angle.

5. The light source device according to claim 1, wherein the light shielding surface of the light shielding portion is pearskin finished.

6. The light source device according to claim 1, wherein the light shielding surface of the light shielding portion is applied with a paint that decreases reflectivity.

7. The light source device according to claim 2, further comprising:
a light receiving element that receives the monitoring light beam; and
an opening member that is arranged on an optical path of the monitoring light beam between the separation optical element and the light receiving element, the opening member including an opening for limiting a beam diameter of the monitoring light beam.

8. The light source device according to claim 7, wherein the opening member is held by the holding member.

9. The light source device according to claim 7, further comprising a condenser lens that is arranged on an optical path of the monitoring light beam between the opening member and the light receiving element, the condenser lens condensing the monitoring light beam passed through the opening of the opening member.

10. The light source device according to claim 9, wherein the condenser lens is held by the holding member.

11. The light source device according to claim 1, wherein the light source includes a plurality of light emitting units arranged in a two-dimensional array.

12. The light source device according to claim 11, wherein the light emitting units are vertical-cavity surface-emitting lasers.

13. An optical scanning device comprising:
a light source device including
a light source that emits a light beam,
a coupling optical system that couples the light beam,
a separation optical element on which the light beam is incident through the coupling optical system, the separation optical element including an opening through which a part of the light beam having a highest light intensity passes, and reflecting other part of the light beam incident on a surrounding area of the opening as a monitoring light beam, and
a light shielding member including at least one of a light shielding portion that is arranged on an optical path between the light source and the coupling optical system to shield a part of the light beam traveling toward an outside of an effective area of the coupling optical system and a light shielding portion that is arranged on an optical path between the coupling optical system and the separation optical system to shield a part of the light beam passed through the outside of the effective area of the coupling optical system;
a deflector that deflects the light beam from the light source device; and
a scanning optical system that condenses the light beam deflected by the deflector onto a scanning surface to be scanned.

14. An image forming apparatus comprising:
at least one image carrier; and
at least one optical scanning device that scans the at least one image carrier by a light beam that is modulated based on image information, the optical scanning device including
a light source device that provides the light beam;
a deflector that deflects the light beam from the light source device; and
a scanning optical system that condenses the light beam deflected by the deflector onto a scanning surface to be scanned, wherein
the light source device includes
a light source that emits a light beam,
a coupling optical system that couples the light beam from the light source,
a separation optical element on which the light beam coupled by the coupling optical system is incident, the separation optical element including an opening through which a part of the light beam having a highest light intensity passes, and reflecting other part of the light beam incident on a surrounding area of the opening as a monitoring light beam, and
a light shielding member including at least one of a light shielding portion that is arranged on an optical path between the light source and the coupling optical system to shield a part of the light beam traveling toward an outside of an effective area of the coupling optical system and a light shielding portion that is arranged on an optical path between the coupling optical system and the separation optical system to shield a part of the light beam passed through the outside of the effective area of the coupling optical system.

15. The image forming apparatus according to claim 14, wherein the image information is color image information.
